(19) United States
(12) Patent Application Publication
(10) Pub. No.: US 2018/0106177 A1
(43) Pub. Date: Apr. 19, 2018

(54) Actuator for a Valve of an Exhaust Heat Recovery Device, in Particular for a Motor Vehicle

(71) Applicant: Faurecia Systemes D'Echappement, Nanterre (FR)

(72) Inventors: Frederic Greber, Ecot (FR); Samir Dahmany, Exincourt (FR)

(21) Appl. No.: 15/387,879

(22) Filed: Dec. 22, 2016

(30) Foreign Application Priority Data
Oct. 19, 2016 (FR) 16 60130

(51) Int. Cl. F01N 5/02; F01N 13/08; F02G 5/02

(52) U.S. Cl. CPC F01N 5/02; F02G 5/02; F01N 13/08

(57) ABSTRACT

An actuator includes a slider intended to actuate a gate, movable between first and second positions, and an urging member to apply an urging force to drive the slider towards a first position when a temperature of the urging member is greater than a predetermined value. The actuator includes an elastic member that applies on the slider a return force towards a second position. The return force is less than the urging force. The urging member is a helical member with shape memory, and is ductile when its temperature is less than the predetermined value, and is formed towards a predefined helical shape when its temperature is greater than the predetermined value.

### CROSS-REFERENCE TO RELATED APPLICATIONS

This application claims priority to FR Application 16 60130, filed Oct. 19, 2016.

### BACKGROUND

The present invention relates to an actuator for a valve of an exhaust heat recovery device, notably for a motor vehicle.

The heat energy contained in exhaust gases represents about 30% of the energy contained in the fuel. A device for heat recovery is intended to transfer this energy to another fluid, such as a coolant liquid.

A heat recovery device includes a valve delimiting a passage between an inlet and an outlet of exhaust gas, wherein the valve houses a movable gate that moves between an obturation position and a position for clearing the passage. The recovery device also includes a heat exchanger comprising an exchanger inlet upstream from the gate and an exchanger outlet downstream from the gate.

The heat exchanger is intended to allow exchange of heat between the exhaust gases passing through this heat exchanger and a heat transfer fluid, notably a coolant liquid.

When the gate is in an obturation position, the circulation of the exhaust gases is forced through the heat exchanger. When the gate is in a clearing position, the exhaust gases circulate through the passage, with the exchanger then being inactive.

The gate is movable depending on the temperature of the heat transfer fluid.

More particularly, when the temperature of the heat transfer fluid is less than a predefined triggering threshold, the gate is in the n obturation position, so that the exhaust gas passes through the heat exchanger and the recovery device is said to be in an energy recovery mode.

On the other hand, when the temperature of the heat transfer fluid is greater than the predefined triggering threshold, the gate is in the clearing position, so that the exhaust gas passes through the passage, the exchanger is inactive, and the recovery device is said to be in a short-circuit mode.

The gate is actuated in a passive way by an actuator, which is sensitive to the temperature of the heat transfer fluid.

In the state of the art, an actuator for a gate of an exhaust heat recovery device is already known, notably from WO 2006 090 725. This actuator includes: a slider intended to actuate the gate, the slider being movable between a first position and a second position, and a member that urges the slider, and which is able to apply an urging force to drive the slider towards its first position when the temperature of this urging member is greater than a predetermined value.

This urging member is formed with a wax capsule. This wax inside the capsule is heated by the heat transfer fluid, and its melting temperature corresponds to said predetermined value.

When the wax melts, it expands considerably. Now, the wax is housed in the capsule, which has a constant volume, so that it urges the slider while expanding.

The slider is connected to the gate of the recovery device, so that this gate is displaced towards its clearing position when the wax expands.

On the other hand, when the temperature of the wax passes below this melting temperature, the wax hardens while contracting, and the slider is returned, for example with a return member, to its initial position, while driving the gate towards its obturation position.

It should be noted that, when the temperature of the wax increases beyond its melting temperature, the wax continues to expand up to a maximum expansion corresponding to a maximum temperature. This expansion induces an additional displacement of the slider, usually called an “over-travel”. Typically for a capsule having a travel of 10 mm obtained at 85° C., the observed over-travel between 85° C. and 130° C. is 3 mm.

This over-travel causes difficulties in the building of the recovery device, notably difficulty in handling of the chain of dimensions, and the handling of significant forces due to the over-travel of the slider while the travel of the slider is limited.

In certain cases, provision may be made for a system for handling the over-travel, but such a system is generally complicated to apply, and induces an increasing force in the wax capsule.

Moreover, it should be noted that the efficiency of the wax decreases with its ageing. A reduction in its volume expansion is actually observed during gradual increase in the number of cycles, which causes a reduction of the travel which attains 20% after 30,000 cycles.

Further, when the device includes an over-travel handling system, the ageing of the wax is accelerated because of the addition of a larger force in the wax capsule.

The object of the invention is notably to find a remedy to these drawbacks, by providing an actuator for a gate of a recovery device not inducing any over-travel problem, and the lifetime of which is improved.

### SUMMARY

For this purpose, the object of the invention is notably an actuator for a valve of an exhaust heat recovery device, notably of a motor vehicle, including:
a slider intended to actuate the gate, the slider being movable between a first position and a second position,
an urging member to urge the slider, and which is able to apply an urging force to drive the slider towards the first position when a temperature of the urging member is greater than a predetermined value, and

wherein:
the actuator includes an elastic member applying on the slider a return force towards the second position, the return force being less than the urging force, and
the urging member is a shape memory helical member, ductile when its temperature is less than said predetermined value, and being formed towards a predefined helical shape when its temperature is greater than the predetermined value.

The urging member is formed with a metal strand in a shape memory alloy, which is spirally wound according to a given geometrical definition, and which has undergone a heat treatment giving it the required properties relative to the transition temperature and to the applied urging force.

When the temperature of the urging member is below the predetermined value (transition temperature), its structure is of the martensitic type, and above the predetermined value, its structure is of the austenitic type.

Thus, at a low temperature, the urging member is very ductile, so that its shape may be easily modified. The urging member then only applies a negligible or zero urging force on the slider.

On the other hand, when the temperature increases beyond the predetermined value, the urging member passes into a super elastic state, and will tend to resume its initial shape, thus applying an urging force on the slider.

Such an urging member in a shape memory material does not have the drawbacks of wax as mentioned earlier. This urging member does not induce any over-travel, and has a lifetime greater than that of wax.

An actuator according to the invention may further include one or several of the following features, taken alone or according to all technically conceivable combinations.
The actuator includes an actuator body delimiting a chamber in which is housed the urging member, the chamber comprising an inlet and an outlet for heat transfer fluid, notably coolant liquid.
The actuator body includes a guiding rod around which is arranged the urging member.
The actuator includes a first element for attaching the urging member, attached in the actuator body, including a threaded portion on which are screwed turns of the urging member.
The actuator includes a second element for attaching the urging member, secured to the slider, including a threaded portion on which are screwed turns of the urging member.
The predefined helical shape of the urging member is with contiguous turns, so that the urging force acts in traction.
The actuator includes a lever cooperating with the slider on the one hand, and intended to cooperate with the gate on the other hand, the slider being able to actuate the gate via this lever.
The elastic member is formed with a coil spring, arranged coaxially with the urging member.

The invention also relates to an exhaust heat recovery device including a valve delimiting a passage between an inlet and an outlet of exhaust gases, and wherein the valve houses a movable gate that moves between an obturation position and a position for clearing the passage, and the recovery device includes a heat exchanger comprising an exchanger inlet upstream from the gate and an exchanger outlet downstream from the gate, and further includes an actuator as defined earlier, the slider of which is cinematically connected to the gate.

These and other features may be best understood from the following drawings and specification.

### BRIEF DESCRIPTION OF THE DRAWINGS

The invention will be better understood upon reading the description which follows, only given as an example and made with reference to the appended figures, among which:

FIG. 1 is an axial sectional view of an actuator according to a first example of an embodiment of the invention; and

FIGS. 2 and 3 are a view similar to FIG. 1 of an actuator according to a second exemplary embodiment of the invention, respectively in a first position and in a second position.

### DETAILED DESCRIPTION

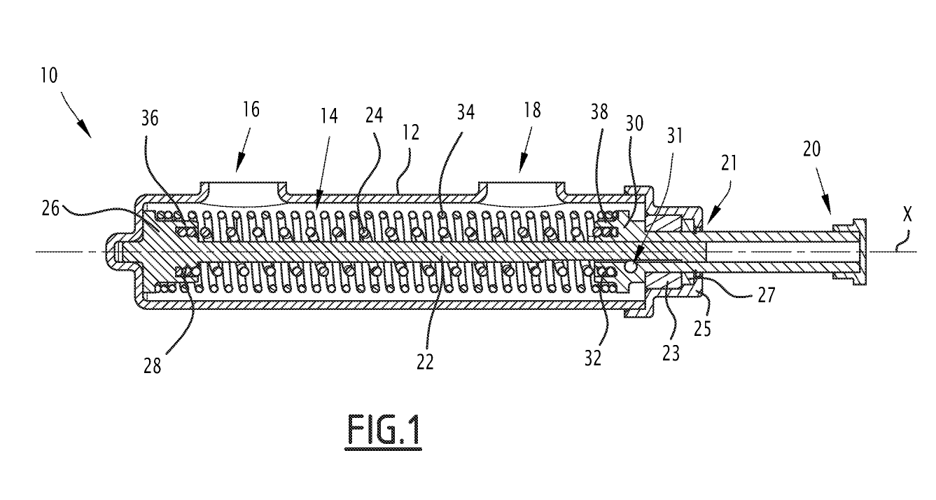

An actuator 10 is illustrated in FIG. 1 for a gate of an exhaust heat recovery device, notably of a motor vehicle.

The actuator 10 includes an actuator body 12, for example with a general cylindrical shape defined around a longitudinal axis X. The actuator body 12 is hollow and therefore delimits a chamber 14.

The actuator body 12 has an inlet opening 16 and an outlet opening 18, both opening into the chamber 14. These inlet 16 and outlet 18 openings are intended to be connected with a network for circulation of heat transfer fluid, notably a coolant liquid.

Thus, the chamber 14 is intended to be filled with a coolant liquid, which circulates through this chamber 14. The temperature in the chamber 14 is therefore the temperature of the coolant liquid.

The actuator 10 includes a slider 20 intended to actuate a gate of the recovery device, notably via a lever.

The slider 20 is movable, notably in the direction of the longitudinal axis X, between a first position (not shown) and a second position (shown in FIG. 1).

The slider 20 for example has a general elongated shape, extending along the direction of the longitudinal axis X, therefore coaxially with the body 12, and notably through an opening 21 made at one end of the body 12. Thus, in the first position, the slider 20 is at least partly retracted in the chamber 14, and in the second position, the slider 20 is at least partly deployed out of the chamber 14.

Advantageously, the body 12 houses a guiding rod 22 extending along the longitudinal axis X. In this case, the slider 20 is hollow and mounted around the guiding rod 22, so as to be able to slide along this guiding rod 22.

The body 12 also includes, in proximity to the opening 21, a bearing 23 also ensuring guiding of the slider 20. Thus, the slider 20 is inserted radially between the guiding rod 22 and the bearing 23.

The bearing 23 is, for example, borne by a cowling 25 attached to the body 12 at the end comprising the opening 21. The cowling 25 further bears a seal gasket 27, preventing leaking of the coolant liquid through the opening 21, and preventing any intrusion through this opening 21.

The seal gasket 27 is, for example, made in a rubbery or elastomeric material, for example in EPDM, fluorocarbon rubber FPM, fluorosilicone MFQ or any equivalent withstanding the coolant liquid on the one hand and aggressive agents which are usually found in ambient air under a motor vehicle, notably salt water, mud, etc.

The actuator 10 includes an urging member 24 to urge the slider 20, and which is able to apply an urging force to drive the slider 20 to its first position when the temperature of this urging member 24 is greater than a predetermined value. This urging member 24 is housed in the chamber 14, and is therefore subject to the temperature of the coolant liquid circulating in this chamber 14.

The urging member 24 is a helical member with shape memory, ductile and is when its temperature is less than said predetermined value, and is formed towards a predefined helical shape when its temperature is greater than the predetermined value.

The urging member 24 is attached at one of its ends to the body 12 and at the other of its ends to the slider 20.

For this purpose, the actuator 10 includes a first attachment element 26 to attach the urging member 24 at one end to the actuator body 12, for example by screwing, in the chamber 14. This first attachment element 26 includes a threaded portion 28 on which are screwed turns of the urging member 24. Thus, the urging member 24 is attached without any welding to the first attachment element 26.

Advantageously, the first attachment element 26 is secured to the guiding rod 22, for example the first attachment element 26 only forms a single part with this guiding rod 22.

Thus, the urging member 24 is arranged around the guiding rod 22, and coaxially with this guiding rod 22.

Moreover, the actuator 10 includes a second attachment element 30 to attach the urging member 24 at an opposite end to the slider 20 in the chamber 14. This second attachment element 30 includes a threaded portion 32 onto which are screwed turns of the urging member 24. Thus, the urging member 24 is attached without any welding to the second attachment element 30.

The second attachment element 30 is blocked in rotation in the body 12, for example by a pin 31 borne by the second attachment element 30, and cooperating with a mating shape made in the body 12. This blocking in rotation gives the possibility of ensuring that the urging member 24 does not unscrew during the displacement of the slider 20.

Advantageously, the second attachment element 30 only forms a single part with the slider 20.

Preferably, the predefined helical shape of the urging member 24 is with contiguous turns, so that the urging force acts in traction. Thus, when the urging member 24 is formed to its predefined shape, the slider 20 is driven towards its first position and is retracted in the chamber 14.

The actuator 10 moreover includes an elastic member 34 applying on the slider 20 a return force towards its second position, the return force being less than the urging force.

The elastic member 34 is, for example, formed with a coil spring arranged coaxially with the urging member 24 and around the guiding rod 22.

In the described example, the elastic member 34 is arranged around the urging member 24. However, alternatively, the urging member 24 may be arranged around the elastic member 34.

The elastic member 34 is supported on the first 26 and second 30 attachment element.

For this purpose, the first attachment element 26 includes another threaded portion 36, on which are screwed turns of one of the ends of the elastic member 34, and the second attachment element 30 includes another threaded portion 38, on which are screwed turns of the other one of the ends of the elastic member 34.

When the temperature of the coolant liquid is less than the predefined value, the urging member 24 is very ductile, so that it applies a negligible or zero force on the slider 20. The slider 20 is therefore only subject to the return force of the elastic member 34, which drives it towards its second position.

On the other hand, when the temperature of the coolant liquid is greater than the predefined value, the urging member 24 tends to assume its initial shape with contiguous turns, so that it applies an urging force on the slider 20, greater than the return force of the elastic member 34. The slider 20 is thus driven towards its first position.

The slider 20 is connected to the gate of the recovery device, in order to displace this gate when this slider 20 moves.

For this purpose, the actuator 10 includes a lever cooperating with the slider 20 on the one hand, and with the gate on the other hand.

Thus, when the temperature of the heat transfer fluid is less than the predefined triggering threshold, the slider 20 is in its second position, and the gate is in an obturation position, so that the exhaust gas passes through the exchanger, with the recovery device being in an energy recovery mode.

On the other hand, when the temperature of the heat transfer fluid is greater than the predefined triggering threshold, the slider 20 moves towards its first position, driving the gate towards a clearing position, so that the exhaust gas passes through the passage, and the exchanger is inactive with the recovery device being in a short-circuit mode.

The gate is thereby actuated in a passive way by the actuator 10, depending on the temperature of the heat transfer fluid.

It will be noted that as the urging member 24 is immersed in the heat transfer fluid, the reaction time of the actuator 10 is very rapid, of the order of one to two seconds, while the reaction time of a wax actuator of the state of the art is of the order of one minute thirty seconds.

The operation of the actuator 10 will now be described in more detail. This operation includes four distinct phases.

During the first phase, operating in an energy recovery mode of the recovery device, the coolant liquid has a temperature less than the transition temperature (predefined value), and the system is then immobile. The elastic return member 34 is preloaded, for example exerting a force of 30 N directed outwards in the direction of the longitudinal axis X. As the urging member 24 is very ductile, it only imposes a marginal force in the system. The slider 20 has attained its maximum travel (50 mm) and the lever is at its maximum angle of 60°. Consequently, the gate is in abutment, obturating the main passage for the exhaust gases.

The second phase is a transition phase. When the coolant liquid attains the transition temperature of the urging member 24, the latter will become super-elastic and will tend to return to its initial shape (with contiguous turns). Consequently, the urging member 24 will apply a force in the direction of the longitudinal axis X, directed towards the inside of the body 12. The second movable attachment element 30 is then set into motion and forces the elastic return member 34 to be compressed. The slider 20 retracts into the chamber 14 and the lever, advantageously displaced by a torsional spring, follows it by opening the gate (passage to the short-circuit mode). It should be noted that the force of the torsional spring is added to that of the urging member 24. Also, it should be noted that during this travel, the force of the elastic member 34 will increase and that of the torsional spring will decrease.

In a third phase (operating in a short-circuit mode), the coolant liquid has a temperature above the transition temperature and the slider 20 will come into its first position, in abutment on the cowling 25. The total travel of the slider 20 is, for example, 50 mm. In this position, the gate will be totally open (short-circuit mode) and in abutment on the valve. The lever is then separated from the slider 20 by about 2 mm.

In a fourth phase, when the coolant liquid drops to a temperature of less than the transition temperature, the urging member 24 resumes its martensitic phase and again becomes very ductile. The force which it exerts becomes again negligible and the elastic return member 34 then forces the slider 20 to resume its initial position in abutment on the lever.

It will be noted that this actuator 10 may have diverse complementary alternatives.

For example, rather than leaving the urging member 24 be directly immersed in the coolant liquid, provision may be made for an intermediate chamber, housed in the chamber 14, and in which the urging member 24 will be housed. In this case, the first attachment member 26 is also housed in the intermediate chamber.

In this case, the seal of the actuator 10 is improved, but the heating of the urging member 24 is longer.

According to another alternative, optionally complementary to the previous one, the slider 20 is connected to the lever by a connecting rod, thereby forming a connecting rod/crank connection. This alternative gives the possibility of doing without the coil spring connected to the gate.

Alternatively, the lever and the slider 20 are connected through a pivot connection.

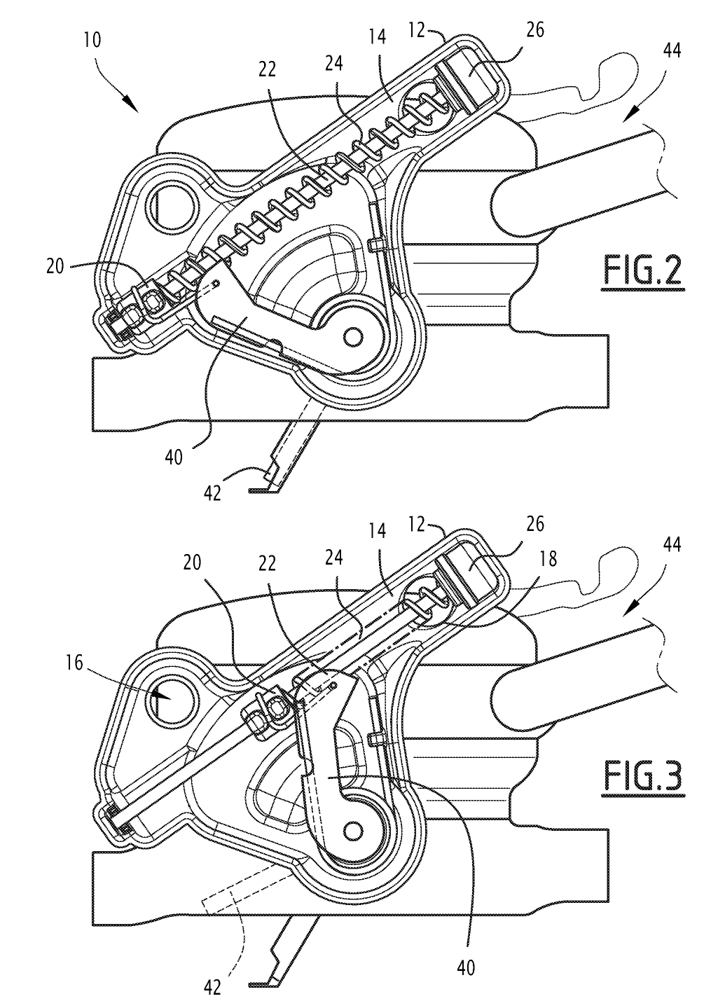

In FIGS. 2 and 3, an actuator 10 according to a second exemplary embodiment of the invention is illustrated. In these figures, the elements similar to those of the first embodiment are designated with identical references.

According to this second embodiment, the body 12 houses a lever 40 in addition to the urging member 24 and to the guiding rod 22.

Further, the slider 20 is also entirely housed in the body 12 in its two positions (respectively represented in FIGS. 2 and 3). This slider 20 is movably mounted along the guiding rod 22.

The lever 40 is connected in rotation to the gate 42 of the recovery device 44.

In FIG. 3, the slider 20 is illustrated in a first position, in which it does not urge the lever 40. The gate 42 is then in an obturation position.

In FIG. 2, the slider 20 is illustrated in a second position, in which it urges the lever 40. The gate 42 is then in a clearing position.

For this purpose, the slider 20 is connected to the lever 40, for example, with a pin.

Like in the first embodiment, the chamber 14 is filled with coolant liquid, and includes an inlet 16 and an outlet 18 for the coolant liquid.

In order to ensure the seal, the actuator includes a seal gasket between the rotating axis of the gate 42 and the body 12. This gasket is made in an adequate material, preferentially in a rubbery or elastomeric material, for example in EPDM, fluorocarbon rubber FPM, fluorosilicone MFQ or any equivalent resisting on one side to the coolant liquid and on the other to the exhaust gas.

According to this second embodiment, the return spring is a torsional spring, with an angular effect defined around the axis of rotation of the lever 40, and connected to the lever 40.

The urging member 24 is attached to a first end of the guiding rod 22 on the one hand by an attachment element 26 having a hollow shape in which the end of the urging member 24 takes position. This hollow shape is the exact shape of the urging member 24 in the new condition, i.e. with contiguous turns and not having yet been subject to deformation.

The attachment element 26 is provided on its periphery with a lug allowing it to be blocked in rotation. A housing for this lug is made in the body 12.

The other end of the urging member 24 is attached to the slider 20, which also has a hollow shape similar to the one of the attachment element 26 for receiving the other end of the urging member 24.

The slider 20, for example, has two pairs of diametrically opposite protrusions, separated by recesses in order to form an X.

The pin connecting the slider 20 to the lever 40 passes into diametrically opposite recesses. The X shape allows the pin to have freedom in rotation of more or less 7°. Each end of the pin is snapped-on to the lever 40. Thus, the slider 20 is blocked in rotation by this pin.

This pin forms a connection between the slider 20 and the lever 40, giving the possibility of avoiding bracing of the slider 20 during its displacement along the guiding rod 22.

The lever 40 is attached on the end of the axis of the gate 42. Its rotation is, for example, 60°, but it may alternatively be smaller (40°) or greater notably up to 90°.

The distance between the axis of the gate 42 and the holes into which the pin will be snapped-on is, for example, 60 mm. The course of the lever 40 at the holes made for the pin is, for example, 60 mm.

It will be noted that the invention is not limited to the embodiments described earlier, but may have diverse complementary alternatives.

Although an embodiment of this invention has been disclosed, a worker of ordinary skill in this art would recognize that certain modifications would come within the scope of this disclosure. For that reason, the following claims should be studied to determine the true scope and content of this disclosure.

1. An actuator for a gate of an exhaust recovery device, notably of a motor vehicle, including:
a slider intended to actuate the gate, the slider being movable between a first position and a second position,
an urging member to urge the slider, and which is able to apply an urging force to drive the slider towards the first position when a temperature of the urging member is greater than a predetermined value, wherein
the actuator includes an elastic member applying on the slider a return force towards the second position, the return force being less than the urging force, and
the urging member is a helical member with shape memory, and which is ductile when the temperature of the urging member is less than the predetermined value and is formed towards a predefined helical shape when the temperature of the urging member is greater than the predetermined value.

2. The actuator according to claim 1, including an actuator body delimiting a chamber (14) in which is housed the urging member, the chamber comprising an inlet and an outlet for heat transfer fluid, notably coolant liquid.

3. The actuator according to claim 2, wherein the actuator body includes a guiding rod around which is arranged the urging member.

4. The actuator according to claim 2, including a first attachment element to attach of the urging member in the actuator body, the first attachment element including a threaded portion on which are screwed turns of the urging member.

5. The actuator according to claim 2, including a second attachment element to attach the urging member to the slider, the second attachment element including a threaded portion on which are screwed turns of the urging member.

6. The actuator according to claim 1, wherein the predefined helical shape of the urging member is with contiguous turns, so that the urging force acts in traction.

7. The actuator according to claim 1, including a lever cooperating with the slider and intended to cooperate with the gate, the slider being able to actuate the gate via the lever.

8. The actuator according to claim 1, wherein the elastic member is formed by a coil spring, coaxially laid out with the urging member.

9. An exhaust heat recovery device, including:
a valve delimiting a passage between an inlet and an outlet of exhaust gases, wherein the valve houses a movable gate that moves between an obturation position and a position for clearing the passage, and the recovery device including a heat exchanger comprising an exchanger inlet upstream from the gate and an exchanger outlet downstream from the gate, and wherein the recovery device includes an actuator
having a slider intended to actuate the gate, the slider being movable between a first position and a second position,
an urging member to urge the slider, and which is able to apply an urging force to drive the slider towards the first position when a temperature of the urging member is greater than a predetermined value, wherein
the actuator includes an elastic member applying on the slider a return force towards the second position, the return force being less than the urging force, and the urging member is a helical member with shape memory, and which is ductile when the temperature of the urging member is less than the predetermined value and is formed towards a predefined helical shape when the temperature of the urging member is greater than the predetermined value, and,
the slider of which is cinematically connected to the gate.
